(19) United States
(12) Patent Application Publication
(10) Pub. No.: US 2017/0145803 A1
(43) Pub. Date: May 25, 2017

(54) Compact Subsea Dehydration

(71) Applicants: Norman K. Yeh, Shenandoah, TX (US); J. Tim Cullinane, Montgomery, TX (US); Tracy A. Fowler, Magnolia, TX (US); Shwetha Ramkumar, Cypress, TX (US); Donald P. Shatto, Houston, TX (US)

(72) Inventors: Norman K. Yeh, Shenandoah, TX (US); J. Tim Cullinane, Montgomery, TX (US); Tracy A. Fowler, Magnolia, TX (US); Shwetha Ramkumar, Cypress, TX (US); Donald P. Shatto, Houston, TX (US)

(21) Appl. No.: 15/262,036

(22) Filed: Sep. 12, 2016

Related U.S. Application Data
(60) Provisional application No. 62/257,495, filed on Nov. 19, 2015.

(51) Int. Cl. E21B 43/36; B01D 53/18; B01D 53/28; B01D 53/14; C10L 3/10; B01D 53/26

(52) U.S. Cl. CPC E21B 43/36; C10L 3/106; B01D 53/263; B01D 53/28; B01D 53/1462; B01D 53/1425; B01D 53/1493; B01D 53/18; C10L 2290/541; C10L 2290/12; B01D 2252/2026

(57) ABSTRACT

Systems and methods for dehydrating a natural gas stream are provided herein. The system includes a lean solvent feed system, including a line from a topsides facility, wherein the line is configured to divide a lean solvent stream to feed lean solvent to each of a number of co-current contacting systems in parallel. The co-current contacting systems are placed in series along a wet natural gas stream, wherein each of the co-current contacting systems is configured to contact the lean solvent stream with the wet natural gas stream to adsorb at least a portion of the water from the wet natural gas stream to form a dry natural gas stream. A rich solvent return system includes a line to combine rich solvent from each of the plurality of co-current contacting systems and return a rich solvent stream to the topsides facility.

### CROSS REFERENCE TO RELATED APPLICATIONS

This invention claims priority to and the benefit of U.S. Patent Application Ser. No. 62/257,495 filed Nov. 19, 2015 entitled COMPACT SUBSEA DEHYDRATION, the entirety of which is incorporated by reference herein.

### FIELD

The present techniques provide for the separation of water from a natural gas stream. More specifically, the present techniques provide for the dehydration using a series of compact co-current contacting systems located in a subsea system.

### BACKGROUND

This section is intended to introduce various aspects of the art, which can be associated with exemplary examples of the present techniques. This description is believed to assist in providing a framework to facilitate a better understanding of particular aspects of the present techniques. Accordingly, it should be understood that this section should be read in this light, and not necessarily as admissions of prior art.

During production of hydrocarbon fluids from underground reservoirs, the produced fluids, natural gas and oil, may also include water, both as a free liquid phase and as water vapor. When production wells are located offshore in deep water, it can be advantageous to complete the wells subsea and produce the well stream into a flow line. The well stream can be transported via pipeline to shore, tied back to a host facility on the topsides, or processed subsea. However, the presence of water can result in hydrate formation, corrosion, and scaling in the flow lines, resulting in blockages, reduced production, or integrity issues. Further, the water vapor may condense along the pipeline or flow line because of the ambient temperature. In natural gas production, the condensation of liquid may also increase the pressure drop because of the multiphase nature of the flow.

In recent years, significant efforts have gone into developing subsea separation systems to physically separate the natural gas, oil, water, and sand that can be found in hydrocarbon production streams, for example, multiline pipe separators such as harp separators. These subsea separation systems can be designed to produce single phase gas and oil streams that can be compressed or pumped, respectively. The water stream can be injected into a disposal well, discharged, or sent to a topsides facility for further processing.

However, physical separation alone only removes free liquid water from the hydrocarbon streams. Water in the vapor phase exits the subsea separation system with the natural gas, and is likely to condense if the ambient temperature of the sea is lower than the dew point of the gas. Further, the water may form hydrates if the temperature is sufficiently low in the line, such as along the walls.

Chemicals, such as methanol or glycol, are injected into the flow in order to prevent or slow the formation of hydrates. Similarly, chemical corrosion inhibitors are also often injected into the flow. These chemicals add to operating costs for the hydrocarbon production. To address corrosion concerns, the pipeline is often designed to be cleaned and inspected by periodic “pigging”. In this case, the pipeline design becomes more complex and costly due to facilities for launching the pig, catching the pig, and the like.

Produced natural gas can be dehydrated to remove the water vapor down to a specified dew point so that condensation will not occur at the expected temperature. The conventional approaches to dehydrating gas in onshore or topsides facilities are to contact the natural gas stream with a liquid solvent or solid desiccant with an affinity for the water. This contacting usually takes place in a pressure vessel, such as a tower for absorption into a liquid solvent or vessels that have hold solid adsorbent. The water is removed by the solvent or desiccant, which is then regenerated and reused. However the equipment necessary to contact the saturated gas with the solvent/desiccant are often relatively large and not well suited for subsea applications, where external pressures are high and the equipment is to be designed to be modular and retrievable.

For example, counter-current contactors used for dehydrating natural gas streams tend to be large and very heavy. Further, the diameter of these systems makes constructing a system that can withstand the pressures of subsea placement impractical. This creates particular difficulty in offshore and subsea oil and gas production applications, where smaller equipment is desirable.

### SUMMARY

A subsea system for dehydrating a natural gas stream is described herein. The subsea system includes a lean solvent feed system, including a line from a topsides facility, wherein the line is configured to divide a lean solvent stream to feed lean solvent to each of a number of co-current contacting systems in parallel. The co-current contacting systems are placed in series along the wet natural gas stream, wherein each of the co-current contacting systems are configured to contact the lean solvent stream with the wet natural gas stream to absorb at least a portion of water from the natural gas stream to form a dry natural gas stream. A rich solvent return system includes a line to combine rich solvent from each of the number of co-current contacting systems and return a rich solvent stream to the topsides facility.

A method for a subsea separation of water from a natural gas stream is described herein. The method includes providing a lean solvent stream to a subsea processing unit. A portion of the lean solvent stream is fed to each of a number of co-current contacting systems. A wet natural gas stream is sequentially contacted with the lean solvent stream in each of the co-current contacting systems to generate a natural gas stream that is at least partially dehydrated and a portion of a rich solvent stream including water. The portions of the rich solvent stream combined and the rich solvent stream to a topsides facility for regeneration.

A system for dehydrating a wet natural gas stream is described. The system includes a lean solvent line to provide a lean solvent stream to a subsea dehydration system. The subsea dehydration system included a number of co-current contacting systems coupled in series along a natural gas stream, wherein each co-current contacting systems is configured to contact the wet natural gas stream with a portion of the lean solvent stream to generate a natural gas stream that is at least partially dehydrated and a rich solvent stream including the water. A rich solvent line is configured to combine the rich solvent streams into a single rich solvent stream and return the single rich solvent stream to a topsides facility. A regeneration system at the topsides facility is configured to regenerate the lean solvent stream.

### DESCRIPTION OF THE DRAWINGS

The advantages of the present techniques are better understood by referring to the following detailed description and the attached drawings, in which:

FIG. 1 is a block diagram of a gas dehydration system;

FIG. 2 is a generalized block diagram of a subsea system for dehydrating a natural gas stream that includes a co-current flow scheme;

FIG. 3 is a schematic of a co-current contacting system;

FIG. 4 is a process flow diagram of a subsea separation system including a number of co-current contacting systems;

FIG. 5 is a process flow diagram of a subsea separation system including a rich solvent return pump on the rich solvent stream;

FIG. 6 is a process flow diagram of a subsea separation system including a lift gas stream;

FIG. 7A is a front view of a contacting device;

FIG. 7B is a side perspective view of the contacting device;

FIG. 7C is a cross-sectional side perspective view of the contacting device;

FIG. 7D is a another cross-sectional side perspective view of the contacting device; and

FIG. 8 is a process flow diagram of a method for subsea dehydration of a natural gas stream using co-current contacting systems.

### DETAILED DESCRIPTION

In the following detailed description section, non-limiting examples of the present techniques are described. However, to the extent that the following description is specific to a particular example or a particular use of the present techniques, this is intended to be for exemplary purposes only and simply provides a description of the exemplary examples. Accordingly, the techniques are not limited to the specific examples described below, but rather, include all alternatives, modifications, and equivalents falling within the true spirit and scope of the appended claims.

At the outset, for ease of reference, certain terms used in this application and their meanings as used in this context are set forth. Further, the present techniques are not limited by the usage of the terms shown below, as all equivalents, synonyms, new developments, and terms or techniques that serve the same or a similar purpose are considered to be within the scope of the present claims.

“Acid gas” refers to any gas that produces an acidic solution when dissolved in water. Non-limiting examples of acid gases include hydrogen sulfide (H₂S), carbon dioxide (CO₂), sulfur dioxide (SO₂), carbon disulfide (CS₂), carbonyl sulfide (COS), mercaptans, or mixtures thereof.

“Co-current contactor” refers to a vessel that receives a gas stream and a separate solvent stream in such a manner that the gas stream and the solvent stream contact one another while flowing in generally the same direction. Non-limiting examples include an eductor and a coalescer, or a static mixer plus deliquidizer.

The term “co-currently” refers to the internal arrangement of process streams within a unit operation that can be divided into several sub-sections by which the process streams flow in the same direction.

As used herein, a “column” is a separation vessel in which a counter-current flow is used to isolate materials on the basis of differing properties. In an absorbent column, a liquid solvent is injected into the top, while a mixture of gases to be separated is flowed into the bottom. As the gases flow upwards through the falling stream of absorbent, one gas species is preferentially absorbed, lowering its concentration in the vapor stream exiting the top of the column, while rich liquid is withdrawn from the bottom.

“Dehydrated natural gas stream” or “dry natural gas stream” refers to a natural gas stream that has undergone a dehydration process. Typically the dehydrated gas stream has a water content of less than 50 ppm, and preferably less than 7 ppm. Any suitable process for dehydrating the natural gas stream can be used. Typical examples of suitable dehydration processes include, but are not limited to dehydration using glycol or methanol.

As used herein, the term “dehydration” refers to the pre-treatment of a raw feed gas stream to partially or completely remove water and, optionally, some heavy hydrocarbons. This can be accomplished by means of a pre-cooling cycle, against an external cooling loop or a cold internal process stream, for example. Water may also be removed by means of pre-treatment with molecular sieves, e.g. zeolites, or silica gel or alumina oxide or other drying agents. Water may also be removed by means of washing with glycol, monoethylene glycol (MEG), diethylene glycol (DEG), triethylene glycol (TEG), or glycerol, as described herein. The amount of water in the gas feed stream is suitably less than 1 volume percent (vol %), preferably less than 0.1 vol %, more preferably less than 0.01 vol %.

The term “distillation” (or “fractionation”) refers to the process of physically separating chemical components into a vapor phase and a liquid phase based on differences in the components' boiling points and vapor pressures at specified temperatures and pressures. Distillation is typically performed in a “distillation column,” which includes a series of vertically spaced plates. A feed stream enters the distillation column at a mid-point, dividing the distillation column into two sections. The top section can be referred to as the rectification section, and the bottom section can be referred to as the stripping section. Condensation and vaporization occur on each plate, causing lower boiling point components to rise to the top of the distillation column and higher boiling point components to fall to the bottom. A reboiler is located at the base of the distillation column to add thermal energy. The “bottoms” product is removed from the base of the distillation column. A condenser is located at the top of the distillation column to condense the product emanating from the top of the distillation column, which is called the distillate. A reflux pump is used to maintain flow in the rectification section of the distillation column by pumping a portion of the distillate back into the distillation column.

As used herein, the term “facility” refers to a system that receives one or more streams of fluids from subsurface facilities, such as a rich solvent stream, among others, and outputs one or more separate streams of fluids to the subsurface facilities, such as a lean solvent stream, among others. Facility is used as a general term to encompass oil and gas field gathering systems, processing platform systems, and well platform systems.

The term “topsides facility” refers to a facility that is above a sea surface, such as a platform, a barge, an FPSO (floating production, storage, and offloading vessel), and the like. The topsides facility can be a shore installation, for example, placed near an offshore gas or gas and oil field.

The term “gas” is used interchangeably with “vapor,” and is defined as a substance or mixture of substances in the gaseous state as distinguished from the liquid or solid state. Likewise, the term “liquid” means a substance or mixture of substances in the liquid state as distinguished from the gas or solid state.

A “hydrocarbon” is an organic compound that primarily includes the elements hydrogen and carbon, although nitrogen, sulfur, oxygen, metals, or any number of other elements can be present in small amounts. As used herein, hydrocarbons generally refer to components found in natural gas, oil, or chemical processing facilities.

With respect to fluid processing equipment, the term “in series” means that two or more devices are placed along a flow line such that a fluid stream undergoing fluid separation moves from one item of equipment to the next while maintaining flow in a substantially constant downstream direction. Similarly, the term “in line” means that two or more components of a fluid mixing and separating device are connected sequentially or, more preferably, are integrated into a single tubular device. Similarly, the term “in parallel” means that a stream is divided among two or more devices, with a portion of the stream flowing through each of the devices.

The term “liquid solvent” refers to a fluid in substantially liquid phase that preferentially absorbs one component over another. For example, a liquid solvent may preferentially absorb water, such as a glycol, thereby removing at least a portion of the water from a gas stream.

The term “stream” indicates a material that is flowing from a first point, such as a source, to a second point, such as a device processing the stream. The stream may include any phase or material, but is generally a gas or liquid. The stream will be conveyed in a line or pipe, and used here, reference to the line or pipe also refers to the stream the line is carrying, and vice versa.

“Natural gas” refers to a multi-component gas obtained from a crude oil well or from a subterranean gas-bearing formation. The composition and pressure of natural gas can vary significantly. A typical natural gas stream contains methane (CH₄) as a major component. i.e., greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., CO₂ or H₂S), or any combinations thereof. The natural gas can also contain minor amounts of contaminants such as water, nitrogen, iron sulfide, wax, crude oil, or any combinations thereof. The natural gas stream can be substantially purified, so as to remove compounds that may act as poisons.

“Solvent” refers to a substance capable at least in part of dissolving or dispersing one or more other substances, such as to provide or form a solution. The solvent can be polar, nonpolar, neutral, protic, aprotic, or the like. The solvent may include any suitable element, molecule, or compound, such as methanol, ethanol, propanol, glycols, ethers, ketones, other alcohols, amines, salt solutions, ionic liquids, or the like. The solvent may include physical solvents, chemical solvents, or the like. The solvent may operate by any suitable mechanism, such as physical absorption, chemical absorption, or the like.

“Substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

### Overview

The present techniques provide for the removal of at least a portion of water from a natural gas stream using compact systems that can be located on a subsea system, for example, near a well or groups of wells. Removing the water from the natural gas stream may decrease the formation of hydrates as the natural gas stream cools, lowering the chances of hydrate fouling of lines to shore or to a topsides facility. The water can be removed from the natural gas stream by contacting the natural gas stream with a solvent stream within a series of co-current contacting systems.

Compact co-current contact separators processing configurations and equipment have been developed to replace a gas-liquid contacting tower for mass transfer and separation. For example, see U.S. Pat. No. 8,899,557 to Cullinane et al. The stages of the co-current contacting systems are composed primarily of inline devices, having smaller diameters than a conventional tower that can be designed to withstand higher internal and external pressures. Further, the inline devices are smaller than conventional pressure vessels, and are thus more suited to modular design/construction, subsea deployment, and to be retrievable. In a dehydration application, two to three co-current contacting systems in series can be used in order to dehydrate gas to meet flow assurance or sales specification requirements.

However, previous configurations used numerous pieces of equipment, such as pumps, controls, for example, to circulate semi-lean solvent from downstream stages to upstream stages. The equipment can be redesigned to enable the deployment of the compact dehydration system subsea. For example, interstage pumps and other equipment can be removed.

The resulting dehydrated natural gas stream may then be transported to a surface vessel or sent to an on-shore processing facility. If present, H₂S and CO₂ can be removed from the natural gas in surface processing. The H₂S and CO₂ can be removed by contacting the natural gas with a solvent stream within a second series of co-current contacting systems.

### Systems for Dehydrating Natural Gas

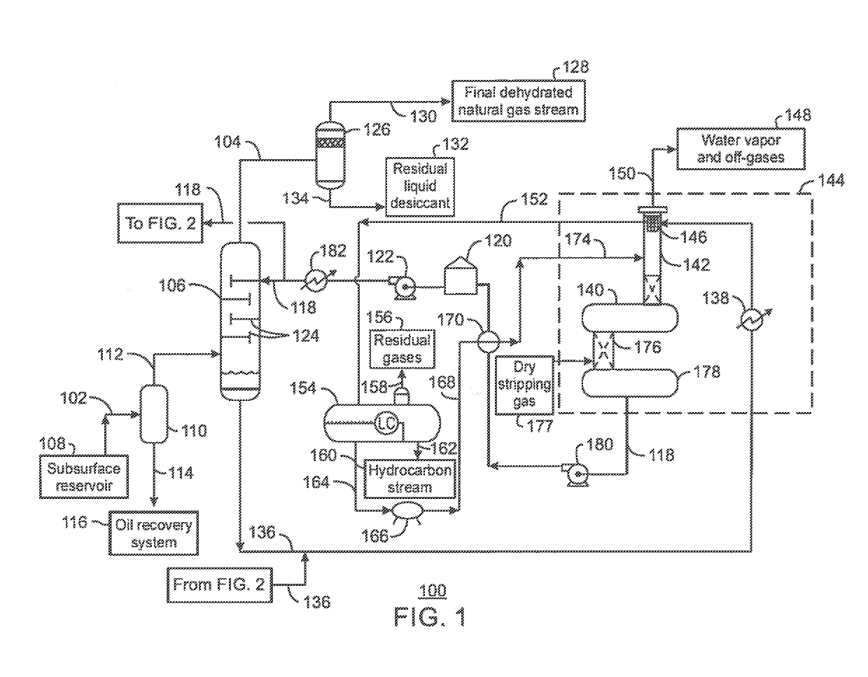

FIG. 1 is a block diagram of a gas dehydration system 100. The gas dehydration system 100 can be used to remove water from a raw natural gas stream 102, or from a lift gas stream, as described herein, to generate a dehydrated natural gas stream 104. This can be accomplished by flowing the raw natural gas stream 102 into a contactor 106, which may remove the water from the raw natural gas stream 102. The dehydrated natural gas stream 104 may then be flowed out of the contactor 106 as an overhead stream.

The raw natural gas stream 102 can be obtained from a subsurface reservoir 108 via any suitable type of hydrocarbon recovery operation. The raw natural gas stream 102 may include a non-absorbing gas, such as methane. In addition, the raw natural gas stream 102 may include water, in addition to other components, such as nitrogen and acid gases, including H₂S and CO₂. For example, the raw natural gas stream 102 may include about 0% to 10% H₂S and about 0% to 10% CO₂, along with the hydrocarbon gas. Water concentration in the natural gas depends on the temperature and pressure in the reservoir and will be at saturation levels for natural gas produced in the presence of water. For example, at higher temperatures, the equilibrium water content of the natural gas will be higher than at lower temperatures. Natural gas with H₂S and CO₂ may hold higher concentrations of water.

As shown in FIG. 1, the raw natural gas stream 102 can be flowed into an inlet separator 110 upon entry into the gas dehydration system 100. When entering the inlet separator 110, the raw natural gas stream 102 can be under a large amount of pressure. However, the pressure of the raw natural gas stream 102 may vary considerably, depending on the characteristics of the subsurface reservoir 108 from which the gas product is produced. For example, the pressure of the raw natural gas stream 102 may range between atmospheric pressure and several thousand psig. For natural gas treating applications, the pressure of the raw natural gas stream 102 can be boosted to about 100 psig or about 500 psig, or greater, if desired.

The inlet separator 110 may clean the raw natural gas stream 102, for example, to prevent foaming of liquid solvent during a later acid gas treatment process. This can be accomplished by separating the raw natural gas stream into liquid-phase components and gas-phase components. The liquid-phase components may include heavy hydrocarbons, water, sand, and other impurities such as brine, fracturing fluids, and drilling fluids. Such components can be flowed out of the inlet separator 110 via a bottoms line 114, and can be sent to an oil recovery system 116 or other type of treater. The gas-phase components may include natural gas and some amount of impurities, such as acid gases and water. Such components can be flowed out of the inlet separator 110 as the overhead natural gas stream 112.

From the inlet separator 110, the natural gas stream 112 can be flowed into the contactor 106. The contactor 106 may use a desiccant or lean solvent stream 118, such as a liquid glycol stream, to absorb water in the natural gas stream 112. The lean solvent stream 118 may include various desiccant liquids, such as triethylene glycol, or other glycols and mixtures, among other desiccant liquids. The lean solvent stream 118 can be stored in a lean solvent tank 120. A high-pressure pump 122 may force the lean solvent stream 118 from the lean solvent tank 120 into the contactor 106 under suitable pressure. For example, the high-pressure pump 122 may boost the pressure of the lean solvent stream 118 to about 1,500 psig or about 2,500 psig, depending on the pressure of the raw natural gas stream 102.

Once inside the contactor 106, gas within the natural gas stream 112 moves upward through the contactor 106. Typically, one or more trays 124 or other internals are provided within the contactor 106 to create indirect flow paths for the natural gas stream 112 and to create interfacial area between the gas and liquid phases. At the same time, the liquid from the lean solvent stream 118 moves downward and across the succession of trays 124 in the contactor 106. The trays 124 aid in the interaction of the natural gas stream 112 with the lean solvent stream 118.

The contactor 106 operates on the basis of a counter-current flow scheme. In other words, the natural gas stream 112 is directed through the contactor 106 in one direction, while the lean solvent stream 118 is directed through the contactor 106 in the opposite direction. As the two fluid materials interact, the down-flowing lean solvent stream 118 absorbs water from the up-flowing natural gas stream 112 to produce the dehydrated natural gas stream 104.

Upon exiting the contactor 106, the dehydrated natural gas stream 104 can be flowed through an outlet separator 126. The outlet separator 126, also referred to as a scrubber, may allow any liquid desiccant carried over from the contactor 106 to fall out of the dehydrated natural gas stream 104. A final dehydrated natural gas stream 128 can be flowed out of the outlet separator 126 via an overhead line 130. Any residual liquid desiccant 132 may drop out through a bottoms line 134.

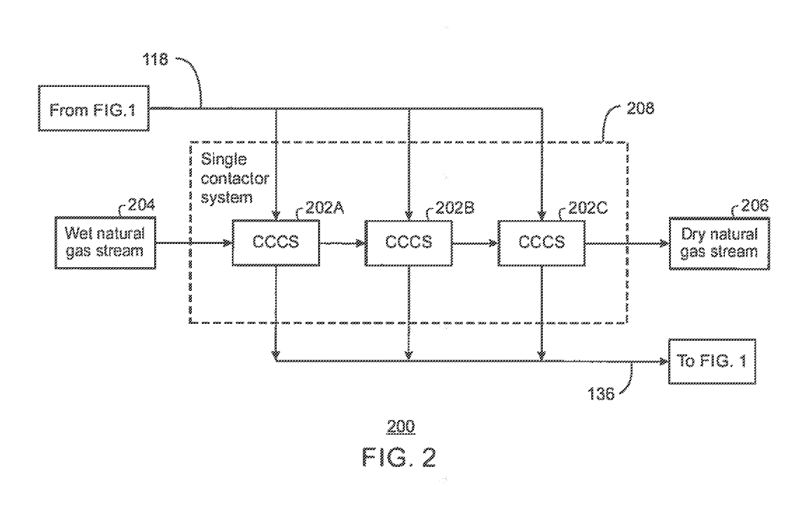

A spent desiccant, or rich solvent stream 136 may flow out of the bottom of the contactor 106. The rich solvent stream 136 can be a glycol solution that is rich in the absorbed water. The rich solvent stream 136 can be at a relatively high temperature, such as about 90° F. to about 102° F., or higher. The gas dehydration system 100 can include a solvent regeneration system for regenerating the lean solvent stream 118 from the rich solvent stream 136, as described further herein. The solvent regeneration system encompasses the equipment along the rich solvent stream 136 flowing out of the contactor 106 and from the subsea separation system described with respect to FIG. 2, through the lean solvent stream 118 that is returned to the contactor 106 and the subsea separation system described with respect to FIG. 2.

From the contactor 106, the rich solvent stream 136 can be heated within a heat exchanger 138 and then flowed into a regenerator 144 (heat exchanger 138 can be separate or part of regenerator 144). The regenerator 144 can be used to regenerate the lean solvent stream 118 from the rich solvent stream 136. The regenerator 144 can be a large pressure vessel, or interconnected series of pressure vessels, that operates at about 15 psig to about 25 psig, for example. The regenerator may include a reboiler 140 that is coupled to a distillation column 142.

The rich solvent stream 136 can be flowed through a tube bundle 146 in the top of the distillation column 142. High-temperature water vapor and off-gases 148 being released from the distillation column 142 may preheat the rich solvent stream 136 as it flows through the tube bundle 146, before the water vapor and off-gases 148 are released via an overhead line 150.

After being preheated within the distillation column 142, the rich solvent stream 136 can be released from the tube bundle 146 as a warmed solvent stream 152. The warmed solvent stream 152 can be flowed into a flash drum 154. The flash drum 154 may operate at a pressure of about 50 psig to about 100 psig, for example, for a glycol stream. The flash drum 154 may have internal parts that create a mixing effect or a tortuous flow path for the warmed solvent stream 152.

Residual gases 156, such as methane, H₂S, and CO₂, can be flashed out of the flash drum 154 via an overhead line 158. The residual gases 156 captured in the overhead line 158 can be reduced to an acid gas content of about 100 ppm if contacted with an amine. This concentration of acid gases can be small enough that the residual gases 156 can be used as fuel gas for the gas processing system 100.

In addition, any entrained heavier hydrocarbons, such as hexane or benzene, within the warmed solvent stream 152 can be separated within the flash drum 154 as a liquid of lesser density than the solvent, e.g., glycol. The resulting hydrocarbon stream 160 can be flowed out of the flash drum 154 via a bottoms line 162.

Further, as the temperature and pressure of the warmed solvent stream 152 drops within the flash drum 154, the hydrocarbons within the warmed solvent stream 152 are separated out, producing a partially-purified solvent stream 164. The partially-purified solvent stream 164 may then be released from the flash drum 154. The partially-purified solvent stream 164 can be flowed through a filter 166, such as a mechanical filter or carbon filter, for particle filtration.

The resulting filtered solvent stream 168 may then be flowed through a heat exchanger 170. Within the heat exchanger 170, the filtered solvent stream 168 can be heated via heat exchange with the lean solvent stream 118. The resulting high-temperature solvent stream 174 can be flowed into the distillation column 142 of the regenerator 144. As the high-temperature solvent stream 174 travels through the distillation column 142, water vapor and off-gases 148, such as H₂S and CO₂, can be removed from the high-temperature solvent stream 174.

The high-temperature solvent stream 174 can be flowed out of the bottom of the distillation column 142 and into the reboiler 140. The reboiler 140 may boil off residual water vapor and off-gases 148 from the high-temperature solvent stream 174. The components that are boiled off may travel upward through the distillation column 142 and be removed as the water vapor and off-gases 148 in the overhead line 150.

The regenerator 144 may also include a separate stripping section 176 fed from the liquid pool in the reboiler 140. The stripping section 176 may include packing that promotes further distillation, as well as dry stripping gas 177, e.g., dehydrated natural gas from a subsea system, nitrogen, or other gases. Any remaining impurities, such as water, H₂S, and/or CO₂, boil off and join the water vapor and off-gases 148 in the overhead line 150. The high-temperature solvent stream 174 may then be flowed into a surge tank 178, from which it can be released as the lean solvent stream 118.

The regenerated lean solvent stream 118 can be pumped out of the surge tank 178 via a booster pump 180. The booster pump 180 may increase the pressure of the lean solvent stream 118 to about 50 psig, for example.

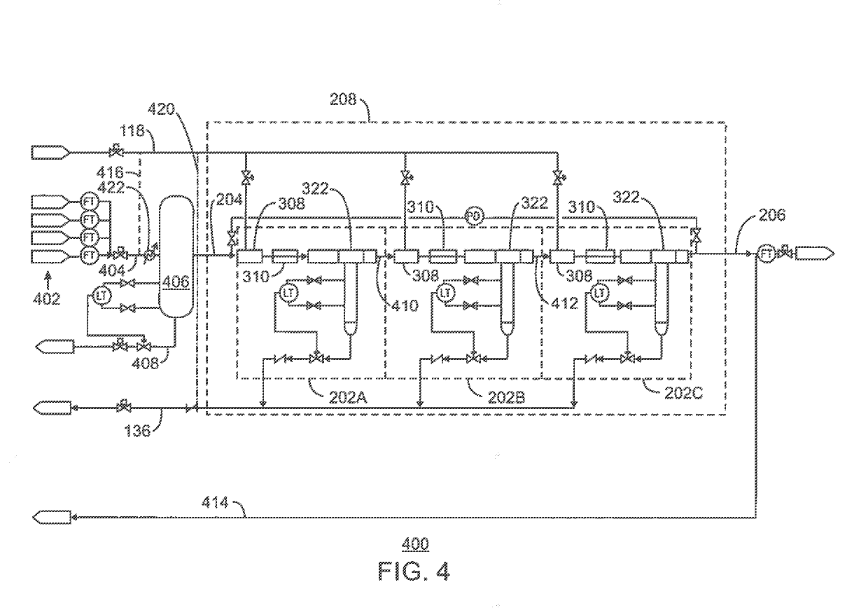

The lean solvent stream 118 may then be flowed through the heat exchanger 170, in which the lean solvent stream 118 can be partially cooled via heat exchange with the filtered solvent stream 168. The lean solvent stream 118 can be stored in the lean solvent tank 120. The high-pressure pump 122 may then force the lean solvent stream 118 from the lean solvent tank 120 through a cooler 182 prior to being returned to the contactor 106. As described herein, the contactor 106 can be replaced with a series of co-current contacting systems, as described with respect to FIGS. 4A to 4C. The contactor 106 can still be used at the surface, for example, to dry a natural gas stream that has been used as a lift gas.

The cooler 182 may cool the lean solvent stream 118 to ensure that the glycol will absorb water when it is returned to the contactor 106. For example, the cooler 182 may chill the lean solvent stream 118 to about 100° F. or 125° F.

The process flow diagram of FIG. 1 is not intended to indicate that the gas dehydration system 100 is to include all of the components shown in FIG. 1. For example, the contactor 106 can be a small unit used to dry a natural gas stream used as a lift gas. The mixed rich solvent and lift gas stream from the subsea separator can come into the inlet separator 110 in place of the raw natural gas stream 102. The rich solvent stream is removed from the inlet separator 110, through the bottoms line 114, and may then be combined into the rich solvent line 136. The flashed gas is sent to counter current contactor 106 in place of the overhead natural gas stream 112. Alternatively, the mixed rich solvent and lift gas stream can be separated in the flash drum 164. Then, the residual gases 166 are sent to the counter current contactor 106 in place of the overhead natural gas stream 112. The resulting dry gas can be used as a stripping gas stream at the topsides facility.

Further, any number of additional components can be included within the gas dehydration system 100, depending on the details of the specific implementation. For example, additional heat can be provided to the reboiler 140 to assist in flashing off the water. Further, the gas dehydration system 100 may include any suitable types of heaters, chillers, condensers, liquid pumps, gas compressors, blowers, bypass lines, other types of separation and/or fractionation equipment, valves, switches, controllers, and pressure-measuring devices, temperature-measuring devices, level-measuring devices, or flow-measuring devices, among others.

Counter-current flow schemes, such as the gas dehydration system 100 of FIG. 1, require comparatively low velocities to avoid entrainment of the down-flowing liquid solvent in the raw natural gas stream 102. Further, relatively long distances are useful for disengagement of the liquid droplets from the raw natural gas stream 102. Depending on the flow rate of the raw natural gas stream 102, the contactor 106 can be greater than 15 feet in diameter, and more than 100 feet tall. For high-pressure applications, the vessel has thick, metal walls. Consequently, counter-current contactor vessels can be large and very heavy. This is generally undesirable, particularly for offshore oil and gas recovery applications, and may not be feasible for subsea applications.

The present technological advancement can utilize a co-current flow scheme as an alternative to the counter-current flow scheme demonstrated in the contactor 106 of FIG. 1. The co-current flow scheme utilizes one or more co-current contacting systems connected in series within a pipe. A natural gas stream and a liquid solvent may move together, i.e., co-currently, within the co-current contacting systems. The natural gas stream and the liquid solvent can move together generally along the longitudinal axis of the respective co-current contacting system. In general, co-current contactors can operate at much higher fluid velocities than counter-current contactors. As a result, co-current contactors tend to be smaller than counter-current contactors that utilize standard towers with packing or trays.

FIG. 2 is a generalized block diagram of a subsea system 200 for dehydrating a natural gas stream that includes a co-current flow scheme. Like numbered items are as described with respect to FIG. 1. The system 200 can be used with the gas dehydration system 100 described with respect to FIG. 1.

The system 200 may employ a number of co-current contacting systems (CCCSs) 202A-202C. A wet natural gas stream 204 is flowed serially through the contactors, starting with co-current contacting system (CCCS) 202A, proceeding through CCCS 202B, and flowing through CCCS 202C. A portion of the water in the wet natural gas stream 204 stream is removed in each contactor, resulting in a dry natural gas stream 206.

As used herein, a dry natural gas is natural gas that contains less than about 50 parts per million by volume (ppmv) of residual water vapor, less than about 20 ppmv of residual water vapor, or less than about 5 ppmv of residual water vapor. The amount of residual water vapor can be controlled by the contact time, the lean solvent flow rate or purity, or, in the co-current contacting system described herein, by the number of co-current contactors used. Although three CCCSs 202A-202C are shown in FIG. 2, any number can be used, depending on the final dryness desired.

Each of the CCCSs 202A-202C can be fed a portion of a lean solvent stream 118 from a regeneration system, for example, as described with respect to FIG. 1. The lean solvent stream 118 can be divided into the portions and flowed in a parallel fashion through the CCCSs 202A-202C, thus, providing lean solvent to each of the CCCSs 202A-202C. After flowing through each of the CCCSs 202A-202C, the solvent is recombined to form the rich solvent stream 136, which can be returned to the surface for processing.

In contrast, previous arrangements have flowed the lean solvent stream 118 into the final CCCS 202C in the series, then flowed the partially lean solvent stream back to the next contactor, CCCS 202B in this example, then flowed the partially rich stream from CCCS 202B back to the first contactor, CCCS 202A in this example. The resulting rich solvent stream was then regenerated. While this arrangement may have made more efficient use of the solvent, pumps may often be used on the solvent streams between the CCCSs 202A-202C stages to boost the pressure. The inclusion of these pumps make the system more problematic for subsea implementation.

In FIG. 2, a single contactor system 208 is shown, for example, using the regeneration system shown in FIG. 1. The system 200 can include a second series of contactors, for example, to remove the water from the rich solvent. The rich solvent stream 136 can be flowed in through the contactors in place of the wet natural gas stream 204. A dry stripping gas would take the place of the lean solvent stream 118 to remove the moisture. In this example, the regeneration would take place at a topsides facility, and thus, the dry stripping gas can be fed to the last contactor in the series, then fed backwards to previous contactors as described above. The system 200 can include any number of additional series of co-current contacting systems not shown in FIG. 2.

### Co-Current Contacting System

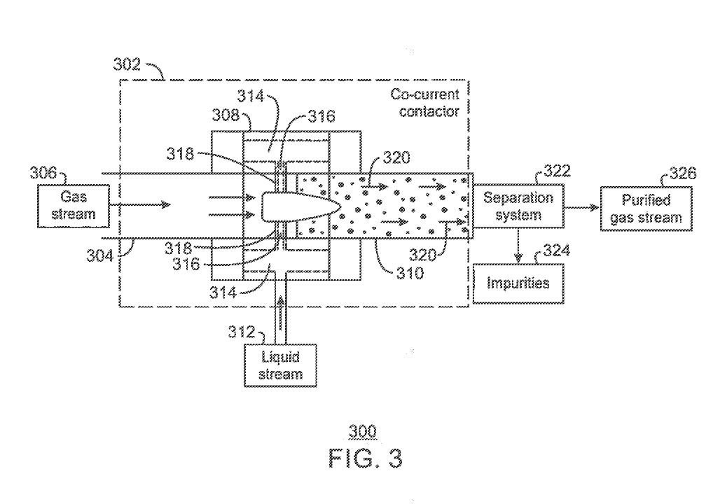

FIG. 3 is a schematic of a co-current contacting system (CCCS) 300. The co-current contacting system 300 can provide for the separation of components within a gas stream. The co-current contacting system 300 of FIG. 3 can be used for each of the CCCSs 202A-202C, described with respect to FIG. 2. The co-current contacting system 300 can include a co-current contactor 302 that is positioned in-line within a pipe 304. The co-current contactor 302 can include a number of components that provide for the efficient contacting of a liquid droplet stream with a flowing gas stream 306. The liquid droplet stream can be used for the separation of impurities, such as H₂O, H₂S, or CO₂, from a gas stream 306.

The co-current contactor 302 can include a droplet generator 308 and a mass transfer section 310. As shown in FIG. 3, the gas stream 306 can be flowed through the pipe 304 and into the droplet generator 308. A liquid stream 312 can also be flowed into the droplet generator 308, for example, through a hollow space 314 coupled to flow channels 316 in the droplet generator 308. The liquid stream 312 can include any type of treating liquid, e.g., solvent, that is capable of removing the impurities from the gas stream 306. For example, the liquid stream 312 can be a lean solvent stream that includes a glycol selected to remove water from the gas stream 306.

From the flow channels 316, the liquid stream 312 is released into the gas stream 306 as fine droplets through injection orifices 318, and is then flowed into the mass transfer section 310. This can result in the generation of a treated gas stream 320 within the mass transfer section 310. The treated gas stream 320 may include small liquid droplets dispersed in a gas phase. The liquid droplets may include impurities from the gas stream 306 that were absorbed or dissolved into the liquid stream 312.

The treated gas stream 320 can be flowed from the mass transfer section 310 to a separation system 322, such as a cyclonic separator, a mesh screen, or a settling vessel. For use in a subsea application, a simpler system may provide more reliability, and thus, a vane mist eliminator combined with a settling vessel can be used. Preferably, inline cyclonic separators can be used to realize the benefits of compactness and reduced diameter. The separation system 322 removes the liquid droplets from the gas phase. The liquid droplets may include the original liquid stream with the incorporated impurities 324, and the gas phase may include a purified gas stream 326. The purified gas stream 326 can be a gas stream that has been dehydrated.

As mentioned herein, the co-current contacting system 300 of FIG. 3 may correspond to one of the CCCSs 202A-202C shown in FIG. 2. Accordingly, if the co-current contacting system 300 corresponds to CCCS 202A then the gas stream 306 corresponds to the wet natural gas stream 204. If the co-current contacting system 300 corresponds to CCCS 202C, the purified gas stream 326 corresponds to the dry natural gas stream 206.

FIG. 4 is a process flow diagram of a subsea separation system 400 including a number of co-current contacting systems (CCCSs) 202A-202C. Like numbered items are as described with respect to FIGS. 1-3. The subsea separation system 400 can be analogous to the contactor 106, for example, as described with respect to FIG. 1, in which each of the CCCSs 202A-202C are acting as bed packing. The subsea separation system 400 can be implemented as part of the subsea system 200 described with respect to FIG. 2. In the illustrative arrangement shown in FIG. 4, a first CCCS 202A, a second CCCS 202B, and a third CCCS 202C are provided. As described herein, the number of CCCSs 202A-202C can be increased or decreased depending on the amount of water in the natural gas stream, the flow rate of the gas stream through the contactors 202A-202C and other factors.

The subsea separation system 400 can be placed on a seafloor, for example, in proximity to a number of gas wells to allow the feed gas 402 from the gas wells to be combined for processing. The combined feed gas 404 can be fed to a separator 406. In the separator 406 water, sand, and other liquid and solid impurities may settle out. A waste line 408 can be used to transport these to the topsides facility for processing.

From the separator 406, a wet natural gas stream 204 can be flowed into the first CCCS 202A. The first CCCS 202A may generate a first partially purified gas stream 410, which can be flowed from the first CCCS 202A to the second CCCS 202B. The second CCCS 202B may then generate a second partially purified gas stream 412, which can be flowed from the second CCCS 202B to the third CCCS 202C. The third CCCS 202C can generate the dry natural gas stream 206, which can be transported to a shore or topsides facility for further processing or sale.

Each of the first, second, and third CCCSs 202A-202C are fed lean solvent from the lean solvent stream 118 from the topsides facility. The rich solvent from each of the CCCSs 202A-202C is combined, and the combined stream, rich solvent stream 136, is returned to the surface for regeneration by water removal. The operating pressure of the absorption is typically much higher than the regeneration system, and this pressure can be used to drive the flow of the rich solvent stream 136 to the regeneration system, for example, as described with respect to FIG. 1.

A separate dry gas stream 414 is shown in FIG. 4. The dry gas stream 414 can be used to provide a stripping gas stream 177, described with respect to FIG. 1 to enhance the regeneration of the solvent. Further, a portion of the dry gas from the dry gas stream 414 can be used as fuel, for example, to power a generator at the surface, provide heat, or both.

Other lines and units can be used to provide further functionality in subsea applications. For example, a lean solvent flush line 416 can be used to provide lean solvent upstream of the separator 406. This can be used to flush the upstream lines and the separator, for example, in case of hydrate formation. Further, a bypass line 420 can be used to couple the lean solvent stream 118 to the rich solvent stream 136. The bypass line 420 may allow the solvent to be flowed through the lines to the subsea separation system 400 during period when the wells are blocked in, keeping the lines from cooling, for example, to keep the viscosity of the solvent from increasing and making system startup and restarts easier. The bypass line 420 can be located before the first CCCS 202A, as shown, or can be located after the last CCCS 202C. Further, the system may have multiple bypass lines, for example, around each of the CCCSs 202A-202C. In addition to, or instead of bypass lines, the solvent flow can be continued through the CCCSs 202A-202C when the natural gas flow is shut-in, protecting the CCCSs 202A-202C from hydrate formation. As natural gas from wells can be hot, e.g., 70° C. or higher, a heat exchanger 422 can be used to exchange heat from the combined feed gas 404 with seawater to lower the temperature before the dehydration process, e.g., to 25° C. or lower. The heat exchanger 422 can be placed upstream of the separator 406, so that any condensed water is removed in the separator 406, although the heat exchanger 422 can be placed in any location prior to the dehydration. Further, the heat exchanger 422 can be placed after the lean solvent flush line 416, so that any hydrates that formed can be removed.

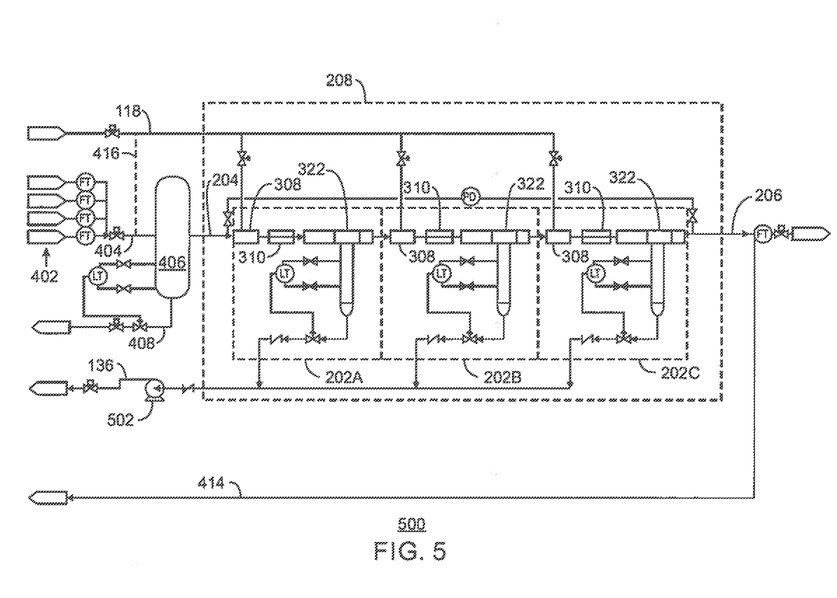

FIG. 5 is a process flow diagram of a subsea separation system 500 including a rich solvent return pump 502 on the rich solvent stream 136. Like numbered items are as described with respect to FIGS. 1-4. Depending on the depth of the subsea separation system 500, the pressure differential may not be sufficiently high to overcome the vertical column of the rich solvent stream 136. Accordingly, the rich solvent stream 136 can be pumped back to the topsides facility. The rich solvent return pump 502 can be driven by electric power, or can be hydraulically powered, for example, using a turbine and the pressure of another stream, such as the lean solvent stream 118 or the natural gas flow, upstream or downstream of the subsea separation system 500.

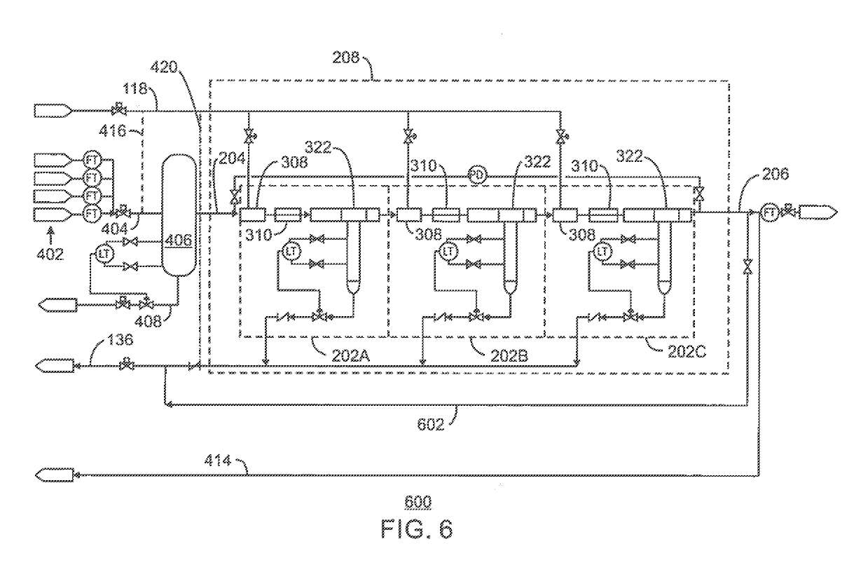

FIG. 6 is a process flow diagram of a subsea separation system 600 including a lift gas stream 602. Like numbered items are as described with respect to FIGS. 1-4. Depending on the depth of the subsea separation system 600, the pressure differential may not be sufficiently high to overcome the vertical column of the rich solvent stream 136. As shown in FIG. 6, a lift gas stream 602 can be used to assist in the return of the rich solvent stream 136. The lift gas stream 602 can be a slip stream of the dry natural gas stream 206, which is combined into the rich solvent stream 136 to reduce the effective density of the rich solvent stream 136 and enable upward flow. During a startup, a lift gas stream 602 can be provided from the topsides facility. The lift gas provided from the surface can be a dry natural gas stream, or can be an inert gas stream, such as a nitrogen stream. Further, natural gas from a shut-in well can be used as the lift gas stream 602 during startup. This can be natural gas from a well that does not need substantial dehydration, but this may not be necessary, as the solvent will function to inhibit any hydrate formation.

If lift gas is used in the rich solvent return, the lift gas may also be used as fuel to run equipment on the topsides facility. When the gas-solvent mixture reaches the topsides facility, the pressure of the gas-solvent mixture is reduced and the mixture is flashed in a separator vessel, such as the inlet separator 110 or flash drum 164 described with respect to FIG. 1. The flash gas may then dried in a small contactor, such as counter current contactor 106, before being routed to the fuel gas system or being used as stripping gas. Depending on the fuel gas requirements of the topsides facility, the lift gas may supply part or all of the fuel needed. The rich solvent stream 136 leaving the flash vessel can be regenerated using a stripper tower and reboiler to produce the lean solvent stream 118 as shown in FIG. 1. As in the previous figures, a separate dry gas line 414 can be used to provide supplemental fuel gas or stripping gas to enhance regeneration of the solvent.

It is to be understood that the subsea separation system is not limited to the number of co-current contacting systems shown in FIGS. 4-6. Rather, the separation system may include any suitable number of co-current contacting systems, depending on the details of the specific implementation. Further, the interconnections within the subsea separation system do not have to be arranged as shown in FIGS. 4-6. Rather, any suitable variations or alternatives to the interconnections shown in FIGS. 4-6 can be present within the separation system, depending on the details of the specific implementation. In addition, any combinations of the lines and equipment shown in FIGS. 4-6 can be made. For example, the bypass line 420 or heat exchanger 422, shown in FIG. 4, can be used in the implementations shown in FIGS. 6 and 6, among others.

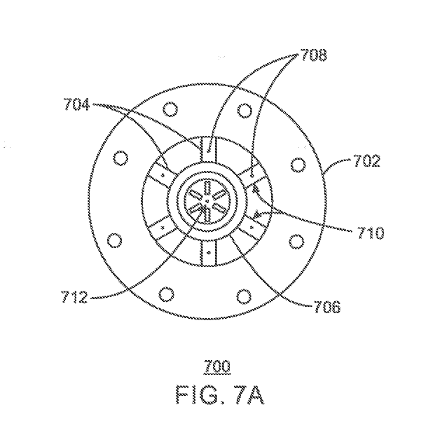

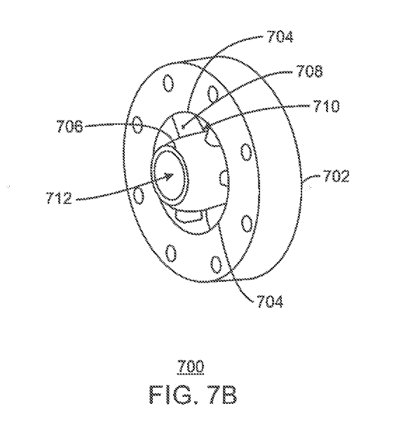

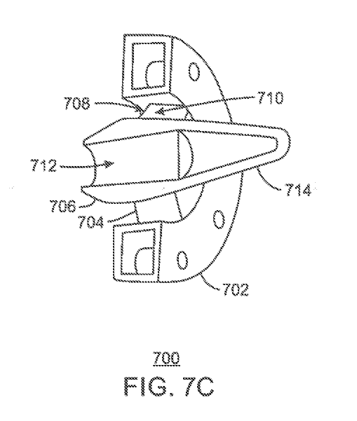

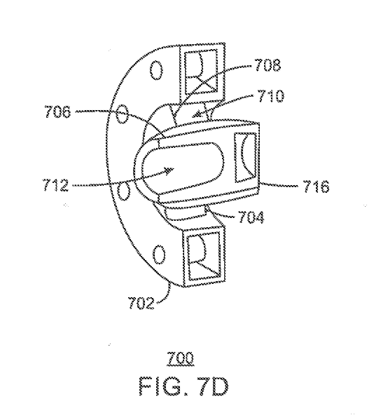

FIG. 7A is a front view of a contacting device 700. The contacting device 700 can be implemented within a co-current contactor, for example, in the co-current contactor 302 described with respect to the co-current contacting system 300 of FIG. 3. The contacting device 700 can be an axial, in-line co-current contactor located within a pipe. The front view of the contacting device 700 represents an upstream view of the contacting device 700.

The contacting device 700 may include an outer annular support ring 702, a number of radial blades 704 extending from the annular support ring 702, and a central gas entry cone 706. The annular support ring 702 may secure the contacting device 700 in-line within the pipe. In addition, the radial blades 704 may provide support for the central gas entry cone 706.

The annular support ring 702 can be designed as a flanged connection, or as a removable or fixed sleeve inside the pipe. In addition, the annular support ring 702 may include a liquid feed system and a hollow channel described further with respect to FIGS. 7C and 7D. A liquid stream can be fed to the contacting device 700 via the hollow channel in the annular support ring 702. The hollow channel may allow equal distribution of the liquid stream along the perimeter of the contacting device 700.

Small liquid channels within the annular support ring 702 may provide a flow path for the liquid stream to flow through liquid injection orifices 708 within the radial blades 704. The liquid injection orifices 708 can be located on or near the leading edge of each radial blade 704. Placement of the liquid injection orifices 708 on the radial blades 704 may allow the liquid stream to be uniformly distributed in a gas stream that is directed between the radial blades 704. Specifically, the liquid stream can be contacted by the gas stream flowing through the gaps between the radial blades 704, and can be sheared into small droplets and entrained in the gas phase.

The gas stream may also be flowed into the central gas entry cone 706 through a gas inlet 712. The central gas entry cone 706 may block a cross-sectional portion of the pipe. The radial blades 704 include gas exit slots 710 that allow the gas stream to be flowed out of the central gas entry cone 706. This may increase the velocity of the gas stream as it flows through the pipe. The central gas entry cone 706 may direct a predetermined amount of the gas stream to the gas exit slots 710 on the radial blades 704.

Some of the liquid stream injected through the radial blades 704 can be deposited on the surface of the radial blades 704 as a liquid film. As the gas stream flows through the central gas entry cone 706 and is directed out of the gas exit slots 710 on the radial blades 704, the gas stream may sweep, or blow, much of the liquid film off the radial blades 704. This may enhance the dispersion of the liquid stream into the gas phase. Further, the obstruction to the flow of the gas stream and the shear edges created by the central gas entry cone 706 may provide a zone with an increased turbulent dissipation rate. The may result in the generation of smaller droplets that enhance the mass transfer rate of the liquid stream and the gas stream.

The size of the contacting device 700 can be adjusted such that the gas stream flows at a high velocity. This can be accomplished via either a sudden reduction in the diameter of the annular support ring 702 or a gradual reduction in the diameter of the annular support ring 702. The outer wall of the contacting device 700 can be slightly converging in shape, terminating at the point where the gas stream and the liquid stream are discharged into the downstream pipe. This can allow for the shearing and re-entrainment of any liquid film that is removed from the contacting device 700. Further, a radial inward ring, grooved surface, or other suitable equipment can be included on the outer diameter of the contacting device 700 near the point where the gas stream and the liquid stream are discharged into the downstream pipe. This can enhance the degree of liquid entrainment within the gas phase.

The downstream end of the contacting device 700 may discharge into a section of pipe (not shown). The section of pipe can be a straight section of pipe, or a concentric expansion section of pipe. The central gas entry cone 706 can terminate with a blunt ended cone or a tapered ended cone. In other embodiments, the central gas entry cone 706 can terminate with a ridged cone, which can include multiple concentric ridges along the cone that provide multiple locations for droplet generation. In addition, any number of gas exit slots 710 can be provided on the cone itself to allow for the removal of the liquid film from the contacting device 700.

FIG. 7B is a side perspective view of the contacting device 700. Like numbered items are as described with respect to FIG. 7A. As shown in FIG. 7B, the upstream portion of the central gas entry cone 706 can extend further into the pipe than the annular support ring 702 and the radial blades 704 in the upstream direction. The downstream portion of the central gas entry cone 706 can also extend further into the pipe than the annular support ring 702 and the radial blades 704 in the downstream direction. The length of the central gas entry cone 706 in the downstream direction depends on the type of cone at the end of the central gas entry cone 706, as described further with respect to FIGS. 7C and 7D.

FIG. 7C is a cross-sectional side perspective view of the contacting device 700. Like numbered items are as described with respect to FIGS. 7A and 7B. According to FIG. 7C, the central gas entry cone 706 of the contacting device 700 terminates with a tapered ended cone 714. Terminating the central gas entry cone 706 with a tapered ended cone 714 may reduce the overall pressure drop in the pipe caused by the contacting device 700.

FIG. 7D is another cross-sectional side perspective view of the contacting device 700. Like numbered items are as described with respect to FIGS. 7A-C. According to FIG. 7D, the central gas entry cone 706 of the contacting device 700 terminates with a blunt ended cone 716. Terminating the central gas entry cone 706 with a blunt ended cone 716 may encourage droplet formation in the center of the pipe.

### Method for Dehydrating a Natural Gas Stream

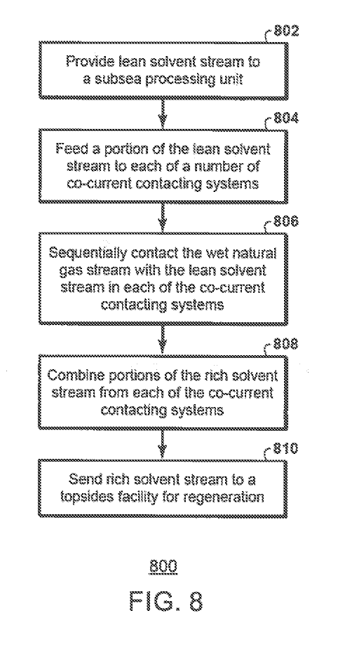

FIG. 8 is a process flow diagram of a method 800 for subsea dehydration of a natural gas stream using co-current contacting systems. The method 800 can be implemented by the series of co-current contacting systems 202A-202C described with respect to the system 200 of FIGS. 2, 4, 5, and 6.

The method 800 begins at block 802 when a lean solvent stream is provided to a subsea processing unit. At block 804 a portion of the lean solvent stream is fed to each of a number of co-current contacting systems in the subsea processing unit.

At block 806, a wet natural gas stream is sequentially contacted with the lean solvent stream in each of the co-current contacting systems to generate a natural gas stream that is at least partially dehydrated and a portion of a rich solvent stream comprising water. At block 808, the portions of the rich solvent stream from each of the co-current contacting systems are combined to form the rich solvent stream. At block 810, the rich solvent stream is sent to a topsides facility for regeneration. This can be performed using an inherent pressure differential, a pump, or a lift gas system.

The dry natural gas stream can be sent to an on-shore facility for further processing, for example, CO₂ and H₂S can be removed from the dry natural gas stream in the on-shore facility. At least a portion the dehydrated natural gas stream can be sent to a processing system located in the topsides facility.

The process flow diagram of FIG. 8 is not intended to indicate that the blocks of the method 800 are to be executed in any particular order, or that all of the blocks of the method 800 are to be included in every case. Further, any number of additional blocks not shown in FIG. 8 can be included within the method 800, depending on the details of the specific implementation.

The methods, processes, and/or functions described herein can be implemented and/or controlled by a computer system appropriately programmed.

Moreover, it is contemplated that features from various examples described herein can be combined together, including some but not necessarily all the features provided for given examples. Furthermore, the features of any particular example are not necessarily required to implement the present technological advancement.

While the present techniques can be susceptible to various modifications and alternative forms, the examples described above are non-limiting. It should again be understood that the techniques is not intended to be limited to the particular embodiments disclosed herein. Indeed, the present techniques include all alternatives, modifications, and equivalents falling within the true spirit and scope of the appended claims.

1. A subsea system for dehydrating a natural gas stream, comprising:
a lean solvent feed system, comprising a line from a topsides facility, wherein the line is configured to divide a lean solvent stream to feed lean solvent to each of a plurality of co-current contacting systems in parallel;
the plurality of co-current contacting systems disposed in series along the wet natural gas stream, wherein each of the co-current contacting systems are configured to contact the lean solvent stream with the wet natural gas stream to absorb at least a portion of water from the natural gas stream to form a dry natural gas stream; and
a rich solvent return system, comprising a line to combine rich solvent from each of the plurality of co-current contacting systems and return a rich solvent stream to the topsides facility.

2. The system of claim 1, comprising a pump configured to assist a flow of the rich solvent stream to the topsides facility.

3. The system of claim 1, comprising a lift gas line configured to remove a lift gas stream from the dry natural gas stream from the subsea system to assist a flow of the rich solvent stream to the topsides facility.

4. The system of claim 3, comprising:
a separation vessel to separate a lift gas stream from the rich solvent stream; and
a generator powered by combusting the lift gas stream.

5. The system of claim 3, comprising a counter-current contactor to dry the lift gas stream before combusting the lift gas stream in the generator.

6. The system of claim 1, comprising a dry gas line configured to remove a portion of the dry natural gas stream to the topsides facility.

7. The system of claim 6, wherein the topsides facility comprises a generator powered by combusting the portion of the dry natural gas stream.

8. The system of claim 1, wherein the lean solvent comprises a glycol.

9. The system of claim 8, wherein the lean solvent comprises triethylene glycol.

10. The system of claim 1, comprising a solvent regeneration system located on a surface vessel.

11. The system of claim 10, wherein the solvent regeneration system comprises a stripping column.

12. The system of claim 10, wherein the solvent regeneration system comprises a second plurality of co-current contacting separators configured to contact a stripping gas stream with the rich solvent stream to form the lean solvent stream and a wet gas stream.

13. The system of claim 12, wherein the stripping gas stream comprises a portion of the dry natural gas stream from the subsea system.

14. The system of claim 1, comprising a lean solvent flush line upstream of a separator configured to allow a lean solvent flush to the separator to prevent or remove hydrates.

15. The system of claim 1, comprising a bypass line from the lean solvent stream to the rich solvent stream configured to allow solvent circulation to be maintained when the subsea separation system is shut down.

16. The system of claim 1, comprising a plurality of bypass lines each proximate to one of the plurality of co-current contacting systems and each configured to allow solvent circulation to be maintained when the subsea separation system is shut down.

17. The system of claim 1, comprising a heat exchanger upstream of the plurality of co-current contacting systems configured to lower a temperature of the wet natural gas stream.

18. A method for a subsea separation of water from a natural gas stream, comprising:
providing a lean solvent stream to a subsea processing unit;
feeding a portion of the lean solvent stream to each of a plurality of co-current contacting systems;
contacting, sequentially, a wet natural gas stream with the lean solvent stream in each of the plurality of co-current contacting systems to generate a natural gas stream that is at least partially dehydrated and a portion of a rich solvent stream comprising water;
combining the portions of the rich solvent stream; and
sending the rich solvent stream to a topsides facility for regeneration.

19. The method of claim 18, comprising sending the natural gas stream that has been at least partially dehydrated to an on-shore facility for further processing.

20. The method of claim 19, comprising removing CO2 and H2S from the natural gas stream in the on-shore facility.

21. The method of claim 18, comprising sending the natural gas stream that has been at least partially dehydrated to a processing system located in the topsides facility.

22. The method of claim 18, comprising pumping the rich solvent stream to the topsides facility.

23. The method of claim 18, comprising combining a lift gas with the rich solvent stream to force the rich solvent stream to the topsides facility.

24. The method of claim 23, comprising providing the lift gas from the topsides facility during startup.

25. The method of claim 23, comprising providing the lift gas from a shut in well.

26. The method of claim 23, comprising:
separating the lift gas from the rich solvent stream at the topsides facility; and
combusting the lift gas to provide power.

27. The method of claim 26, comprising drying the lift gas prior to combusting.

28. The method of claim 27, comprising utilizing the dried lift gas as a stripping gas.

29. A system for dehydrating a wet natural gas stream, comprising:
a lean solvent line to provide a lean solvent stream to a subsea dehydration system;
the subsea dehydration system comprising a plurality of co-current contacting systems coupled in series along a natural gas stream, wherein each co-current contacting systems is configured to contact the wet natural gas stream with a portion of the lean solvent stream to generate a natural gas stream that is at least partially dehydrated and a rich solvent stream comprising the water;
a rich solvent line configured to combine the rich solvent streams into a single rich solvent stream and return the single rich solvent stream to a topsides facility; and
a regeneration system at the topsides facility configured to regenerate the lean solvent stream.

30. The system of claim 29, comprising a second series of co-current contacting systems configured to contact the rich solvent stream with a stripping gas to regenerate the lean solvent stream and generate a waste gas stream comprising the water and the stripping gas.

31. The system of claim 30, wherein the stripping gas comprises a dry natural gas stream from the subsea separation system.

32. The system of claim 11, wherein each of the plurality of co-current contacting systems comprises:
a co-current contactor located in-line within a pipe, the co-current contactor comprising:
a contacting device, comprising:
an annular support ring configured to maintain the contacting device within the pipe;
a plurality of radial blades extending from the annular support ring and configured to allow a liquid stream to flow into the contacting device; and
a central gas entry cone supported by the plurality of radial blades and configured to allow a gas stream to flow through a hollow section within the contacting device; and
a mass transfer section downstream of the contacting device;
wherein the contacting device and the mass transfer section provide for efficient incorporation of liquid droplets formed from the liquid stream into the gas stream; and
a separation system configured to remove the liquid droplets from the gas stream.

33. The system of claim 32, wherein the separation system comprises a cyclonic separator.

34. The system of claim 32, wherein a downstream portion of the central gas entry cone comprises a blunt ended cone.

35. The system of claim 32, wherein a downstream portion of the central gas entry cone comprises a tapered ended cone.

36. The system of claim 29, wherein the lean solvent stream comprises triethylene glycol (TEG).
